(19) United States
(12) Patent Application Publication
(10) Pub. No.: US 2025/0182737 A1
(43) Pub. Date: Jun. 5, 2025

(54) Speech Synthesizer and Method for Speech Synthesis

(71) Applicant: Siemens Aktiengesellschaft, München (DE)

(72) Inventors: Raphaela Groten, Aachen (DE); Rebecca Johnson, München (DE)

(73) Assignee: Siemens Aktiengesellschaft, München (DE)

(21) Appl. No.: 18/842,141

(22) PCT Filed: Mar. 23, 2023
(86) PCT No.: PCT/EP2023/057477

§ 371 Date: Aug. 28, 2024

(30) Foreign Application Priority Data
May 17, 2022 (DE) 10 2022 204 888.1

(51) Int. Cl. G10L 13/027; G10L 25/30

(52) U.S. Cl. CPC G10L 13/027; G10L 25/30

(57) ABSTRACT

Various embodiments of the teachings herein include a speech synthesizer. An example includes: a processor with a speech analysis module to analyze and process natural language for content and an emotional module to perform emotional modeling of the utterance; a neural network with an AI system; a microphone; and a memory storing a recording of natural and/or artificially spoken speech as acoustic data. The processor receives, analyzes, and processes the acoustic data stored in the memory. The neural network provides a suggestion for the emotional modeling with regard to content of the utterance. The AI system develops a suggestion for the emotional modeling on the basis of appropriate training data at least partly generated by human interaction.

### CROSS-REFERENCE TO RELATED APPLICATIONS

This application is a U.S. National Stage Application of International Application No. PCT/EP2023/057477 filed Mar. 23, 2023, which designates the United States of America, and claims priority to DE Application No. 10 2022 204 888.1 filed May 17, 2022, the contents of which are hereby incorporated by reference in their entirety.

### TECHNICAL FIELD

The present disclosure relates to a speech synthesizer and method for speech synthesis.

### BACKGROUND

There is an ever growing number of applications in which it is advantageous if, in addition to a text output of a solution proposed by the computer-aided system—see e.g., navigation systems—spoken output modules also reproduce the solution that the system has calculated. A natural-language human-computer interaction is becoming ever more popular and also technically feasible due to deep-learning algorithms. However, for a natural exchange between human and computer, emotional modeling of the vocal range is also necessary. The input variables and models required for this represent a technical challenge, because the understanding, i.e. also the synthetic reproduction, of emotions delivered via speech melodies is not yet very advanced. For example, a significant majority of an audience can tell whether a purely acoustically reproduced speaker is smiling or not during their speech.

The computer-aided systems with spoken output use speech synthesis and speech synthesizers as well as methods for speech synthesis. Speech synthesis means the artificial production of the human speaking voice. Text-to-speech systems that convert continuous text into an acoustic speech output are already available. These systems essentially use robot voices that speak the texts. Different techniques for speech synthesis can be used, either signal generation or signal modeling. Signal modeling relies on speech recordings, but the problem of producing a natural speech melody and/or emotional modeling is a particular problem for any form of speech synthesis.

### SUMMARY

The teachings of the present disclosure include speech synthesizers which improve the existing systems with regard to speech melody and/or the emotional modeling of artificial speech. For example, some embodiments of the teachings herein include a speech synthesizer, comprising the following modules, at least one processor and at least one neural network with an AI system on which a generic algorithm is programmed: at least one microphone module with recording function, at least one memory module, which stores a recording of natural and/or artificially spoken speech in the form of acoustic data and via a suitable interface and forwards said recording to at least one processor, which receives, analyzes and processes the acoustic data from the memory module, the processor being configured such that it has at least one speech analysis module, which analyzes and processes natural language so that the content of the utterance is formulated correctly, wherein the at least one processor is configured such that it also has an emotional module, which performs the emotional modeling of the utterance in synthetic speech, wherein the two modules are connected to a neural network that has an artificial intelligence system AI, which provides a suggestion for the emotional modeling with regard to the content of the utterance, wherein the AI system develops the suggestion for the emotional modeling on the basis of appropriate training data, which is at least partly generated by human interaction, and a generic algorithm, and finally, a loudspeaker module for the reproduction of the synthetic speech.

In some embodiments, the speech synthesizer includes a speech processing model which uses a deep learning architecture to generate human-like text.

In some embodiments, the speech synthesizer includes an interface to a library.

In some embodiments, the speech synthesizer includes a module for capturing human emotions that has a series of controllers, each of which can be assigned to different emotions.

In some embodiments, the speech synthesizer includes at least one microphone module having at least one filter for noise selection.

In some embodiments, the speech synthesizer includes at least one microphone module, which not only captures speech, but also breathing sounds.

In some embodiments, the speech synthesizer includes at least one memory module, which is suitable for comparing acquired data with already existing data.

In some embodiments, the speech synthesizer includes at least one memory module which is suitable for compressing incoming data.

As another example, some embodiments include a method for speech synthesis, comprising: i) playing back synthetic and/or human speech, j) capturing one or more human responses to this speech in real time, k) converting the captured data into machine-processable data, l) storing the data, m) repeating these elements, n) forwarding this data as training data to a neural network which is configured to provide solutions for speech synthesis via generic programming and taking this data into account, o) implementing the suggestions for speech synthesis generated by the AI system by means of a suitably configured processor, and p) outputting the synthesized speech.

In some embodiments, the human response with regard to emotions such as: admiration, pleasure, fear, annoyance, approval, compassion, confusion, curiosity, desire, disappointment, disapproval, disgust, embarrassment, agitation, anxiety, gratitude, sorrow, joy, love, nervousness, optimism, pride, awareness is captured during the speech.

In some embodiments, the extent of the human response with regard to the emotions is captured.

In some embodiments, filler words in the speech are captured.

In some embodiments, breathing sounds of the speaker are captured.

In some embodiments, the method is repeated once to 1,000 times.

In some embodiments, a classification of the various learned emotional models is provided.

### DETAILED DESCRIPTION

Some embodiments of the teachings herein a speech synthesizer comprising the following modules, at least one processor and at least one neural network with an AI system on which a generic algorithm is programmed:
at least one microphone module with recording function
at least one memory module which stores a recording of natural and/or synthetically spoken speech in the form of acoustic data and, via a suitable interface, forwards said recording to at least one
processor, which receives, analyzes and processes the acoustic data from the memory module, the processor being configured such that it has at least one speech analysis module, which analyzes and processes natural language so that the content of the utterance is formulated correctly,
wherein the at least one processor is configured such that it also has an emotional module, which performs the emotional modeling of the utterance in synthetic speech,
wherein the two modules are connected to a neural network that has an artificial intelligence (AI) system, which provides a suggestion for the emotional modeling with regard to the content of the utterance, wherein the AI system develops the suggestion for the emotional modeling based on appropriate training data which is at least partly generated by human interaction, and a generic algorithm, and
finally, a loudspeaker module for the reproduction of the synthetic speech.

Generic algorithms, programming and corresponding feedback loops, including those with human interaction, can be used to provide solutions for emotionally modeling speech using AI in a speech synthesizer equipped in such a way, which enable the production of a very natural sounding speech melody. During the operation of the speech synthesizer, a learning process must first be carried out so that the training data of the AI system is supplemented by the feedback obtained from human listeners.

In contrast to well-known Speech. Emotion Recognition “SER” systems, which automatically recognize and map emotions via frequencies, sound volume, rhythm, etc. using convolutional neural networks, the speech synthesizer presented here for the first time uses feedback loops with human listeners, so that the training data for the AI system used includes not only machine-detectable and technically measurable data, but is also based in particular on feedback with human listeners. This makes a significant difference, because the prosody assigned by human beings allows for much more differentiated and far-reaching statements than the previously used automatic recording by the known programs such as SER.

The feedback loops, which the speech synthesizer uses in the learning mode, are therefore based on the feedback of the already known data available in libraries and/or programs of different programming languages, but at least also on assessments of human listeners. For example, it has been found that human listeners can classify—with limitations of course—but to a significant level of accuracy, whether or not a speaker of a purely acoustic reproduction is smiling when speaking. This human ability is captured by the speech synthesizer proposed here and converted into digitally processable data that can be used for speech synthesis via AI.

A prototype of the speech synthesizer revealed a significant increase in the naturalness of the synthetic speech thus produced. This is due in particular to the fact that here the pitch contour, the profile of the pitch, through training with human interaction, in the AI system makes the synthetic speech, in particular for Western languages, less so for the Asian languages, sound more animated and emotional.

A computer architecture used in natural language processing and/or generation (NLP) is a neural network based on a deep learning model.

Common libraries and/or programs, which also form a basis of the speech synthesizer described here, may include, for example, speech processing models, in particular autoregressive speech processing models, as GPT such “Generative Pre-trained Transformer”. This refers to a series of Natural Language Processing (NLP) models, GPT1 through GPT3, where deep learning is used to generate and/or process natural language.

Common libraries that can be used, for example, in the configuration of the at least one processor and/or the programming of the AI system are, for example, Python and LIWC “Linguistic Inquiry Word Count”, which are already used for computational linguistics applications. Emotion assignment using generic AI algorithms has so far also been carried out, for example, using BERT, GPT3, GitHub and/or Copilot and supplemented by the speech synthesizer proposed here.

By supplementing the training data for the speech synthesis with feedback and feedback loops with human listeners, the pool of training data for the AI system described here is expanded in arbitrary ways, because queries that cannot be understood by machines, such as “How likely is it that the candidate has passed the oral exam?” or “Was the candidate hired?”, which can be answered by the human listener not just from the content but from the speech melody alone, can be incorporated into the training of the AI system. This is the reason that this speech synthesizer is equipped with one or more microphones.

The training data is generated by human listeners, in particular including the emotions that are assigned to the recording. For example, the queries relate to whether the speaker is smiling, speaking authentically, whether one “believes” what he or she is saying, or whether uncertainties can be detected in the speech melody. This can be done in combination with the content and/or independently of the content, for example by listening to a foreign human language. The training data can then be transferred arbitrarily to different examples of content, which, for example, do not match either in terms of words or meaning, but require the human speaker to use the same speech melody.

The purpose of the training of the AI system is then to recognize which content the speech melody fits. For example, certain moods are also assigned to certain items of content in relation to the speech melodies. The following emotions can be assigned to the respective acoustic data in different levels of accuracy: is the speaker expressing admiration, pleasure, fear, annoyance, approval, compassion, confusion, curiosity, desire, disappointment, disapproval, disgust, embarrassment, agitation, anxiety, gratitude, sorrow, joy, love, nervousness, optimism, pride, awareness? If so, to what extent?

For example, the human listener can indicate their perception in numerical values from 1 to 10.

To capture these human emotions and convert them into machine-processable data, so-called modules for capturing human emotions are provided. For example, a human listener can operate various input modules when listening. Thus, the human being can sit in front of a series of controls and sliders, each representing different emotions. Thus the person—while listening—can move the control “gratitude, disapproval, anger, fear, irony, pleasure . . . ” along a continuous scale and in doing so, provide the data that the AI system needs for training in the generic method. The same inputs can also be made by the listener via touchscreen and/or keyboard.

For training, human speakers are recorded in various situations and analyzed accordingly, wherein each mood can be assigned a value so that the training data for a speech melody in connection with the analyzed content of the utterance can assign data to as many moods as possible. From this training data, which is generated by human listeners with the aid of the microphones and the classifications performed simultaneously, the AI system can suggest speech melodies for certain items of content in connection with a given content, which are then played back through the loudspeaker very authentically.

The training data of the AI system is thus generated on the one hand by feedback loops of human utterances with human listeners and on the other by feedback loops of synthetically generated utterances with human listeners.

In some embodiments, the microphone or microphones, which are part of the speech synthesizer, have one or more filters that accurately detect the pitch of the spoken utterance, whether synthetic or human. Suitable filters for audio recordings can meet various requirements regarding noise selection and are known to the person skilled in the art.

In some embodiments, the microphone or microphones have devices that also detect breathing sounds. For example, it is provided that the microphone comprises two or more channels through which the speech and the breathing sounds are recorded simultaneously, but on different audio tracks, so that in feedback loops the two recordings can be presented separately or combined.

In some embodiments, the microphone or microphones detects/detect the exact position of the speaker, so that speech directed at the microphone self-confidently in a front-facing position for processing by the AI system provides different acoustic data than speech from a less confident speaker, possibly even holding their head in a lowered position and/or facing away from the microphone, with otherwise the same pitch contour, etc.

The memory module for storing the generated acoustic data may be configured such that a conversion of the acoustic data into machine-readable data takes place. For example, the memory module may be equipped with a program to compress the data.

In some embodiments, the memory module is designed such that the data can be compared with already stored acoustic data, so that data which are repetitions and therefore generate no added value for the training of the AI system, are at least not forwarded, but in particular, for example, kept separate. This data can nevertheless be stored in another location or else deleted.

A “processor” means a machine and/or an electronic circuit. In particular, a processor may be a main processor (Central Processing Unit, CPU), a microprocessor or a microcontroller, for example an application-specific integrated circuit or a digital signal processor, possibly in combination with a memory unit for storing program commands, etc. For example, a processor may also be an IC (integrated circuit), in particular an FPGA (Field Programmable Gate Array) or an ASIC (Application-Specific Integrated Circuit), or a DSP (Digital Signal Processor) or a GPU (Graphics Processing Unit).

A processor can also mean a virtualized processor, a virtual machine, or a soft CPU. It may also be, for example, a programmable processor which is equipped with configuration steps for carrying out the methods described herein or is configured with configuration steps in such a way that the programmable processor realizes the features of the methods or the modules, or other aspects and/or partial aspects.

A “module” means a device such as a microphone and/or a memory unit for storing acoustic and visual data. By way of example, the processor is specifically designed to execute the digital representation such that the AI system performs functions for implementing or realizing pattern analysis, pattern recognition and/or pattern prediction and/or a step of the method according to the invention. For example, the respective modules can also be designed as separate or stand-alone modules. For example, the corresponding modules may comprise other elements. For example, these elements are one or more interfaces (e.g. database interfaces, communication interfaces—e.g. network interface, WLAN interface) and/or an evaluation unit (e.g. another processor) and/or a memory unit. The interfaces can be used, for example, to exchange data (for example, receive, transmit, send or provide data). By means of the evaluation unit, data can be compared, verified, processed, assigned or calculated, for example, in a computer-aided and/or automated manner. By means of the memory unit, data can be stored, retrieved or provided, for example, in a computer-aided and/or automated manner.

In addition, some embodiments of the teachings herein include a method for speech synthesis comprising:
a) playing synthetic and/or human speech,
b) simultaneously capturing one or more human responses to this speech in real time
c) converting the captured data into machine-processable data,
d) storing the data
e) repeating steps a) to d)
f) forwarding this data as training data to a neural network which is configured to provide solutions for speech synthesis using generic programming and taking this data into account,
g) implementing the suggestions for speech synthesis generated by the AI system by means of a suitably configured processor and
h) outputting the synthesized speech.

The repetition cycles of a) to d) are arbitrary, and can be between 1 and 10,000, in particular between 1 and 1,000 or between 1 and 100 repetitions. “Prosody” is the totality of the sound characteristics of the speech that are not bound to the sound and/or the phoneme as a minimum segment, but to more extensive sound units. These include the following properties: word and sentence accent, the lexical tone located on word syllables in tonal languages. Prosody includes the typical rhythm of speech, intonation and/or stress patterns of a language. By means of this speech synthesizer and/or this method for speech synthesis, artificial speech is generated taking the prosody into account.

Thus, any technically undetectable data can be used in connection with an utterance for training the AI system, for example: speech rhythm, speech melody in conjunction with content, which in turn allow statements to be made as to eye contact, facial expressions, head posture and, above all, data that is technically undetectable by sensors, such as “Did the human/synthetic speech sound authentic?” or “Was the human/synthetic speech awkward?” “stressed?” “focused?” “calm?” “friendly?” “Did his state of mind change during the speech?” “Did he keep to a constant speaking rate?”.

It should also be possible to draw these conclusions from the synthetic speech, so that synthetic speech sounds as natural as possible. In this case, the proposed speech synthesizer and/or the proposed method for speech synthesis do not require an explicit understanding of the modeling of emotions in the vocal range but rely on feedback through human interaction instead. The only important thing is that it works, that the emotion is recognizable in the artificial voice, not the understanding of how this happens.

In addition, the acoustic data can be used to capture indirect emotions, such as “did the human speaker use many or few filler words?” “did that change during the speech?” “when did filler words appear?” in certain types of content such as “Uh, hmm, throat clearing . . . ” When were there any pauses in the speech? How did the speech melody relate to the content?

The learning process must be distinguished from the application. AI is based on the known tools for speech synthesis and extends these tools to include data generated by human interaction. In some embodiments, a classification of the various emotional nuances learned is provided, so that a rapid definition on the part of the user is possible.

The speech synthesizer and/or the speech synthesis methods described herein make use of an AI system with a generic algorithm and at least one feedback loop through the interaction with human listeners, allows voices with appropriate emotional modeling to be created synthetically.

What is claimed is:

1. A speech synthesizer, comprising:
processor with a speech analysis module to analyze and process natural language to formulate content of an utterance and an emotional module to perform emotional modeling of the utterance in synthetic speech;
a neural network with an AI system programmed with a generic algorithm;
a microphone with recording;
a memory storing a recording of natural and/or artificially spoken speech as acoustic data;
wherein processor receives, analyzes, and processes the acoustic data stored in the memory;
wherein the speech analysis module and the emotional module are connected to the neural network;
wherein the neutral network provides a suggestion for the emotional modeling with regard to content of the utterance;
wherein the AI system develops a suggestion for the emotional modeling on the basis of appropriate training data at least partly generated by human interaction; and
a speaker for reproducing synthetic speech.

2. The speech synthesizer as claimed in claim 1, further comprising a speech processing model using a deep learning architecture to generate human-like text.

3. The speech synthesizer as claimed in claim 1, further comprising an interface to a library.

4. The speech synthesizer as claimed in claim 1, further comprising a module to capture human emotions with a series of controllers, each of which can be assigned to different emotions.

5. The speech synthesizer as claimed in claim 1, wherein the microphone includes a filter for noise selection.

6. The speech synthesizer as claimed in claim 1, wherein the microphone captures breathing sounds.

7. The speech synthesizer as claimed in claim 1, wherein the memory stores acquired data for comparison with already existing data.

8. The speech synthesizer as claimed in claim 1, wherein the memory compresses incoming data.

9. A method for speech synthesis, the method comprising:
playing back synthetic and/or human speech;
capturing one or more human responses to the speech in real time;
converting the captured data into machine-processable data;
storing the machine-processable data;
repeating the above multiplicity of times;
forwarding the machine-processable data as training data to a neural network to provide solutions for speech synthesis via generic programming based on the machine-processable data;
implementing suggestions for speech synthesis generated by the AI system by means of a suitably configured processor; and
broadcasting the synthesized speech.

10. The method as claimed in claim 9, further comprising capturing human response with regard to emotions including: admiration, pleasure, fear, annoyance, approval, compassion, confusion, curiosity, desire, disappointment, disapproval, disgust, embarrassment, agitation, anxiety, gratitude, sorrow, joy, love, nervousness, optimism, pride, and/or awareness.

11. The method as claimed in claim 10, further comprising capturing and intensity of the human response.

12. The method as claimed in claim 9, further comprising identifying filler words in the speech.

13. The method as claimed in claim 9, further comprising identifying breathing sounds of the human speaker.

14. The method as claimed in claim 9, wherein the multiplicity of times is from 2 to 1,000 times.

15. The method as claimed in claim 1, wherein the processor provides a classification of the various learned emotional models.
